(19) United States
(12) Patent Application Publication
(10) Pub. No.: US 2024/0198249 A1
(43) Pub. Date: Jun. 20, 2024

(54) SPEED CONTROL DEVICE PROJECTING A LIGHT TARGET

(71) Applicant: Sylvain QUENDEZ, Bouchemaine (FR)

(72) Inventor: Sylvain QUENDEZ, Bouchemaine (FR)

(21) Appl. No.: 18/286,699

(22) PCT Filed: Apr. 11, 2022
(86) PCT No.: PCT/IB2022/053396

§ 371 Date: Oct. 12, 2023

(30) Foreign Application Priority Data
Apr. 13, 2021 (FR) FR2103816

(51) Int. Cl. A63K 99/00; G07C 1/24

(52) U.S. Cl. CPC A63K 99/00; G07C 1/24

(57) ABSTRACT

A device for controlling pace, intended to be physically secured to a person (for example by way of a belt or a harness) or any other moving body (for example a bicycle, a horse or a remote-controlled car), having:
a means for periodically ascertaining the pace of the device;
a means periodically ascertaining a target pace;
a means for projecting a light target onto elements in the environment of the device;
a means for orienting said projection; and
a means for controlling said orientation, wherein one of its functions is to give the impression that the light target is moving over the surface of said elements in the environment at said target pace.

### TECHNICAL FIELD

The invention falls within the field of sports assistance solutions. More specifically, the invention relates to systems and methods allowing participants in racing sports to control their pace.

### PRIOR ART

In racing sports, during training or in competition, maximizing performance often depends on maintaining a predetermined pace.

However, maintaining a pace is difficult. Athletes therefore commonly use assistive solutions, which may be classified into two categories:
Category 1: methods using a target moving at the desired pace and that it is sufficient to follow. The target is for example a specialist athlete (colloquially called “hare”), a vehicle, or even a light target projected onto the ground from a vehicle. The target may also be represented by a light track arranged along the route.
Category 2: personal electronic devices equipped with a GPS receiver, such as sports watches or smartphones having sports activity tracking applications, which compute the athlete's speed and alert the athlete that they are not maintaining pace by way of an on-screen display or an audible message.

The methods in category 1 are instinctive to use, but they are difficult to implement. The devices in category 2 are easy to implement, but they are difficult to use effectively when all attention is taken up by exertion.

### PRESENTATION OF THE INVENTION

The aim of the invention is to provide a solution for controlling pace that is both easy to implement—since it may be included in a portable device—and instinctive to use—since it is based on the principle of following a target.

To this end, the invention relates to a device for controlling pace, intended to be physically secured to a person (for example by way of a belt or a harness) or to any other moving body (for example a bicycle, a horse or a remote-controlled car).

The device comprises:
1. a means for periodically ascertaining the pace of the device;
2. a means for periodically ascertaining a target pace;
3. a means for projecting a light target onto elements in the environment of the device;
4. a means for orienting said projection; and
5. a means for controlling said orientation, characterized in that one of its functions is to give the impression that the light target is moving over the surface of said elements in the environment at said target pace.

Depending on the activity performed, the light target is projected onto the ground, the road, the track, the bottom of the swimming pool, a wall of the bobsleigh track, or any other elements in the environment of the device.

The projected light target is for example: a spot, a line, a symbol, text, an image, or any other figure, possibly formed of superimposed or separate sub-figures.

The invention is applicable to all racing sports (for example running, swimming, skiing, cycling, horse riding), including those with an interposed object (for example remote-controlled cars), and more generally to all activities involving progress under a time constraint (for example movements on foot of soldiers or rescuers).

Other features and advantages will become apparent on reading the following detailed description.

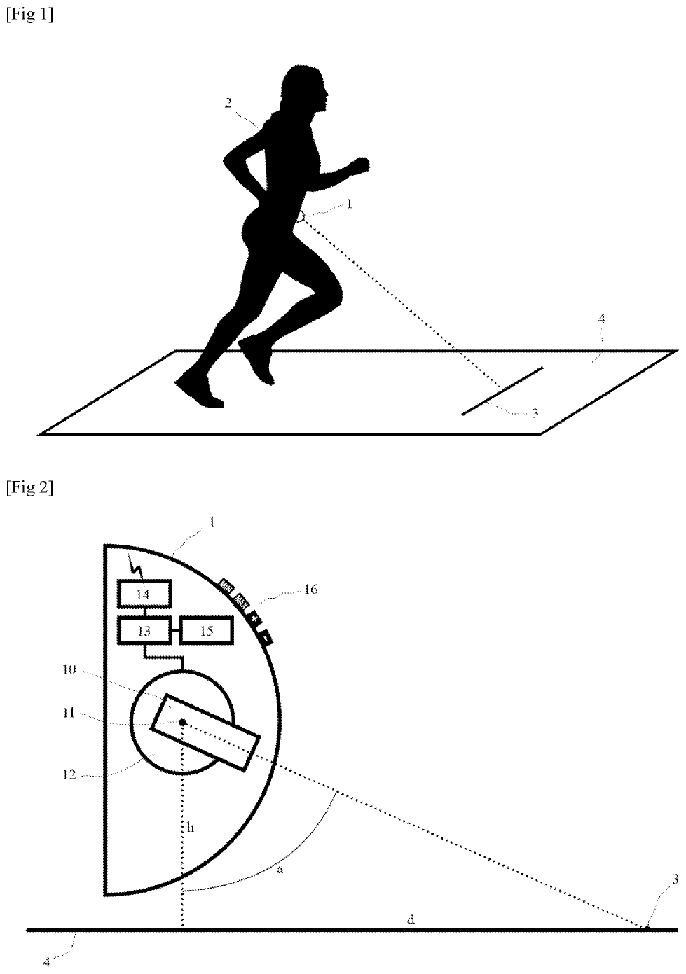

### BRIEF DESCRIPTION OF THE DRAWINGS

[FIG. 1] A schematic depiction of a runner equipped with the device that is the subject of the invention, according to one particular embodiment and use mode of the invention.

[FIG. 2] A schematic sectional view of the device that is the subject of the invention, according to one particular embodiment and use mode of the invention.

### DETAILED DESCRIPTION

In the following description, paragraphs not beginning with the phrase “In one variant” concern the particular embodiment and use mode shown in FIGS. 1 and 2. On the contrary, paragraphs beginning with “In one variant” concern other use modes or embodiments of the invention.

The device 1 that is the subject of the invention is attached to a runner 2 by way of a belt.

In one variant, the device is fastened to another moving body, such as a bicycle, a horse or a remote-controlled car.

The device comprises a line-generating laser module 10 that projects a light target 3 in the form of a straight-line segment, said laser module constituting one example of a means for projecting a light target.

The light target 3 is projected onto the ground 4, the components of the ground constituting one example of elements in the environment of the device.

The laser module 10 is fastened to the axle 11 of a brushless motor 12, thereby allowing it to be oriented in the plane of the figure at an angle a, the motor and its axle constituting one example of a means for orienting the projection.

In one variant, the means for orienting the projection comprises interlocking gimbal/motor pairs, like in an electric gimbal stabilizer for a camera, which make it possible to orient the projection according to the three degrees of freedom (roll, pitch, yaw).

In one variant, the means for orienting the projection comprises mirrors mounted on galvanometers, which reflect the beam of a fixed laser, thus making it possible:
1. to orient the projection according to the three degrees of freedom (roll, pitch, yaw); and
2. to create light targets with complex shapes, by virtue of persistence of vision.

The angle a of the brushless motor 12 is controlled by a microcontroller 13 whose program makes it possible to project the target at the desired distance d, said microcontroller and its program constituting one example of a means for controlling the orientation.

The Bluetooth interface 14 makes it possible to connect the device to a sports watch or a smartphone having a sports activity tracking application capable of providing the pace of the device and the target pace (the latter may be variable over time, for example depending on the terrain), said interface constituting one example of a means for periodically ascertaining the pace of the device and the target pace.

In one variant that is independent of any external device, the device comprises:
1. a GPS receiver, which makes it possible to compute the pace of the device by deriving the position as a function of time, said GPS receiver constituting another example of a means for periodically ascertaining the pace of the device; and
2. a user interface, formed for example of a digital screen and buttons, allowing the user to enter one or more target paces, said user interface constituting another example of a means for periodically ascertaining the target pace.

The program of the microcontroller 13 dynamically varies the angle a to give the impression that the light target is moving over the surface of the elements in the environment at the target pace Ac, therefore independently of the pace of the device Ad.

The algorithm of the program is based on the following logic:
1. The linear speed, relative to the device, to be given to the light target is given by:

$$\dot{d} = A c - A d \qquad [ Math 1 ]$$

2. If the height h between the device and the ground is approximated at a constant value of 1 meter, the relationship between the angle a and the distance d expressed in meters is given by the expression:

$$a = {tan}^{- 1} d \qquad [ Math 2 ]$$

3. If Math 2 is derived as a function of time and Math 1 is injected, this gives the desired angular speed at any time for the motor 12:

$$\dot{a} = ( Ac - Ad ) {cos}^{2} a \qquad [ Math 3 ]$$

where Ac and Ad are expressed in meters per second, a is expressed in degrees and the result is expressed in degrees per second.

The four buttons 16 allow the user to set the minimum and maximum distances from the light target to the device:
1. The buttons MIN and MAX are selectors for selecting the distance to be set. When one of them is held down, it communicates to the microcontroller 13 the order to change to forced mode and to project the target at the corresponding distance.
2. The buttons + and − may then be used to increase or reduce the minimum or maximum distance thus selected.

Said buttons constitute one example of a means allowing the user to set at least one of the operating parameters. Said forced mode constitutes an additional function of the means for controlling the orientation in addition to that described in paragraph 0025.

In one variant in which the means for orienting the projection is capable of orienting the projection according to the three degrees of freedom (roll, pitch, yaw), some buttons also make it possible to set the initial position of the light target, which may thus be positioned laterally, for example on the side of a bicycle or on the walls of a bobsleigh track.

In one variant, the setting buttons are replaced with a Bluetooth interface for connection to a smartphone having an application for parameterizing the device, said interface constituting another example of a means allowing the user to set at least one of the operating parameters.

The inertial unit 15 transmits the accelerations of the device according to the six degrees of freedom to the program of the microcontroller 13, said inertial unit constituting one example of a means for ascertaining the movements of the device.

The following two accelerations, caused by the vibrations of the device and the movements of the body of the runner, cause parasitic displacements of the light target that it is desirable to suppress:
1. translational acceleration g1 in the direction of the course, when it is greater than the possible acceleration of a runner (4 m/s²); and
2. rotational acceleration g2 in the plane of the figure.

The program of the microcontroller 13 acts on the angle a to cancel out the ground displacements of the light target that are caused by these two parasitic accelerations, thereby constituting one example of at least partially compensating for the effects of the movements of the device on the position of the light target. The new formula for the desired angular speed is therefore:

$$\dot{a} = [ Ac - ( Ad - \int g 1 dt ) ] {cos}^{2} a - \int g 2 dt \qquad [ Math 4 ]$$

The Bluetooth interface 14 makes it possible to connect the device to a sports watch or a smartphone having a sports activity tracking application capable of providing periodic information about the inclination of the ground 4, said interface constituting one example of a means for periodically ascertaining the geometric characteristics of the elements in the environment onto which the light target is projected.

The inclination of the ground introduces an inaccuracy that it is advantageous to correct in the program of the microcontroller 13, this correction constituting one example of the use of said geometric characteristics to reinforce the impression that the light target is moving at the target pace. Generalizing the calculation Math 2, it is found that the angle a to give to the motor 12 is now:

$$a = {sin}^{- 1} \frac{d cos p}{l} with : l = \sqrt{1 + {d}^{2} - 2 d sin p} \qquad [ Math 5 ]$$

p being the angle of inclination of the ground with respect to the horizontal.

The desired angular speed is derived therefrom at any time:

$$\dot{a} = \frac{cos p [ Ac - Ad ] ( 1 - d sin p )}{{l}^{2} \sqrt{{l}^{2} - {( d cos p )}^{2}}} \qquad [ Math 6 ]$$

Thereby giving, after injection of the compensation for the two parasitic accelerations g1 and g2 described in paragraph 0030:

$$\dot{a} = \frac{cos p [ Ac - ( Ad - \int g 1 dt ) ] ( 1 - d sin p )}{{l}^{2} \sqrt{{l}^{2} - {( d cos p )}^{2}}} - \int g 2 dt \qquad [ Math 7 ]$$

In one variant, the device comprises a GPS receiver that makes it possible to compute the inclination of the ground by deriving the altitude, said GPS receiver constituting another example of a means for periodically ascertaining the geometric characteristics of the elements in the environment onto which the light target is projected.

1. A device for controlling pace, intended to be physically secured to a person or to any other moving body, comprising:
a. a means for periodically ascertaining the pace of the device;
b. a means for periodically ascertaining a target pace;
c. a means for projecting a light target onto elements in the environment of the device;
d. a means for orienting said projection at an angle (a) with respect to the vertical; and
e. a means for controlling said orientation, wherein one of its functions is to dynamically vary said angle (a) so as to give the impression that said light target is moving over the surface of said elements in the environment at said target pace.

2. The device as claimed in claim 1, furthermore comprising a means allowing the user to set at least one of the following operating parameters:
a. the initial position of the light target, before displacement thereof on the basis of the pace;
b. a minimum distance from the light target to the device, below which it cannot go;
c. a maximum distance from the light target to the device, above which it cannot go.

3. The device as claimed in claim 1, furthermore comprising a means for ascertaining the movements of the device, and wherein the control means acts on the angle (a) on the basis of said movements of the device so as to cancel out the displacements of the light target over the elements in the environment that are caused by said movements of the device and thus at least partially compensate for the effects of said movements on the position of the light target.

4. The device as claimed in claim 1, furthermore comprising a means for periodically ascertaining the geometric characteristics of the elements in the environment of the device, and wherein the control means acts on the angle (a) on the basis of said geometric characteristics in order to correct the effect of said geometric characteristics on the projection of the light target onto these said elements in the environment and thus to reinforce the impression that the light target is moving over the surface of said elements in the environment at the target pace.

5. The device as claimed in claim 2, furthermore comprising a means for ascertaining the movements of the device, and wherein the control means acts on the angle (a) on the basis of said movements of the device so as to cancel out the displacements of the light target over the elements in the environment that are caused by said movements of the device and thus at least partially compensate for the effects of said movements on the position of the light target.

6. The device as claimed in claim 2, furthermore comprising a means for periodically ascertaining the geometric characteristics of the elements in the environment of the device, and wherein the control means acts on the angle (a) on the basis of said geometric characteristics in order to correct the effect of said geometric characteristics on the projection of the light target onto these said elements in the environment and thus to reinforce the impression that the light target is moving over the surface of said elements in the environment at the target pace.

7. The device as claimed in claim 3, furthermore comprising a means for periodically ascertaining the geometric characteristics of the elements in the environment of the device, and wherein the control means acts on the angle (a) on the basis of said geometric characteristics in order to correct the effect of said geometric characteristics on the projection of the light target onto these said elements in the environment and thus to reinforce the impression that the light target is moving over the surface of said elements in the environment at the target pace.
